(19) United States
(12) Patent Application Publication
(10) Pub. No.: US 2009/0249642 A1
(43) Pub. Date: Oct. 8, 2009

(54) METHOD OF THERMALLY TREATING WOOD

(76) Inventors: Yasar Kocaefe, Chicoutimi (CA); Duygu Kocaefe, Chicoutimi (CA)

Correspondence Address: OGILVY RENAULT LLP, 1, Place Ville Marie, SUITE 2500, MONTREAL, QC, H3B 1R1, CA

(21) Appl. No.: 12/304,370

(22) PCT Filed: Jun. 28, 2007
(86) PCT No.: PCT/CA2007/001160

§ 371 Date: Dec. 11, 2008

Related U.S. Application Data
(60) Provisional application No. 60/817,098, filed on Jun. 29, 2006.

(51) Int. Cl. B27K 5/00; F26B 3/04; F26B 25/00

(52) U.S. Cl. 34/508; 34/227

(57) ABSTRACT

There is provided a method of treating wood in a treatment chamber. A plurality of wood pieces are provided in the treatment chamber. The wood pieces are positioned in a spaced-apart wood array configuration and define a non-linear path therebetween for circulating a gas flow. A gas flow is then circulated along the non-linear path between the wood pieces in a general gas flow direction.

### CROSS-REFERENCE TO RELATED APPLICATIONS

The present application claims priority of U.S. provisional patent application No. 60/817,098 filed on Jun. 29, 2006. The specification of which is hereby incorporated by reference.

### TECHNICAL FIELD

The present invention relates generally to wood thermal treatment methods and systems, and more particularly to drying or high temperature treatment methods for instance.

### BACKGROUND OF THE ART

The field of wood treatment includes for example, wood drying processes as well as methods for thermally treating wood at high temperatures. Conventional wood drying processes entail heating the wood to temperatures ranging between 80 and 120° C. with warm gases. The gas humidity is precisely controlled during the drying process to ensure that the gas is not too humid nor too dry. Notably, if the gas is too humid, the wood does not dry, and if the gas is too dry, the wood dries too quickly thereby causing the surface to harden. A hardened wood surface leads to the formation of cracks and overall deformation of the wood.

For high temperature treatment, the wood is usually heated to higher temperatures (above 200° C.) than for drying purposes thereby causing a modification in the wood cellular structure. Treating wood at high temperatures substantially increases its hardness, dimensional stability and resistance to biological degradation caused by insects and micro-organisms. Furthermore, high temperature treated wood acquires an interesting coloration that is attractive for finished products. As a result, the acquired characteristics of thermally treated wood make it propitiously suited for use as a substitute to chemically treated wood, such as the wood treated with chromated copper arsenate (CCA).

Generally, large quantities of wood blocks are processed simultaneously to minimize costs. The wood blocks are stacked in a pile and treated with hot gas such that the wood blocks located in the center of the pile are underexposed while the surrounding wood blocks are overexposed to the hot gas. As a result, the wood blocks are not uniformly processed yielding undesirable results.

Therefore, there exists a need for a method of drying and/or thermally treating wood that promotes uniform results.

### SUMMARY

It is therefore an aim of the present invention to provide a method of thermally treating wood that addresses at least some of the above-mentioned problems.

Therefore, in accordance with one aspect, there is provided method of treating wood in a treatment chamber. A plurality of wood pieces are provided in the treatment chamber. The wood pieces are positioned in a spaced-apart wood array configuration and define a non-linear path therebetween for circulating a gas flow. A gas flow is then circulated along the non-linear path between the wood pieces in a general gas flow direction.

In accordance with another aspect, there is provided a method of treating wood in a treatment chamber. A plurality of wood pieces is provided in the treatment chamber. A first row of wood pieces is positioned in spaced-relation in the treatment chamber and defines a spacing between adjacent wood pieces. A second row of wood pieces is positioned in spaced-relation in the treatment chamber and adjacent to the first row and spaced therefrom such that the second row follows the first row in a general gas flow direction. The second row is offset from the first row. Wood pieces of the second row are substantially aligned with the spacing between wood pieces of the first row such that such the said wood pieces define a non-linear path between the wood pieces. A gas flow is circulated on the non-linear path between the wood pieces in the general gas flow direction.

In accordance with another aspect, there is provided a wood treatment chamber comprising a wood support having separators and a gas inlet and outlet. The wood support positions a plurality of wood pieces in a wood array configuration in the treatment chamber. The array configuration defining a non-linear path between the wood pieces. Separators in said wood support space-apart the wood pieces of the plurality for circulating a gas flow. The gas inlet and outlet generates the gas flow on the non-linear path in-between the wood pieces in a general gas flow direction.

In accordance with another aspect, there is provided a wood treatment system comprising a wood treatment chamber having a wood support with separators, and a gas inlet and outlet. The wood support positions a plurality of wood pieces in a wood array configuration in the treatment chamber. The array configuration defining a non-linear path between the wood pieces. Separators in said wood support space-apart the wood pieces of the plurality for circulating a gas flow. The gas inlet and outlet generates the gas flow on the non-linear path in-between the wood pieces in a general gas flow direction. The wood treatment system further comprises a gas treatment unit for controlling a temperature and a humidity of the gas flow and a fan for circulating said gas flow from said wood treatment chamber, to the gas treatment unit and again to the wood treatment chamber.

### BRIEF DESCRIPTION OF THE DRAWINGS

FIG. 1 is a schematic view of a system for drying and/or thermally treating gas;

FIG. 2 is a schematic front view of the array configuration of wood blocks inside a wood treatment chamber in accordance with a particular embodiment of the present invention;

FIG. 3 is a schematic perspective view of the wood blocks of FIG. 2;

FIG. 4 is a schematic perspective view of the wood blocks of FIG. 2 showing the wood support used to support the wood blocks in the treatment chamber;

FIG. 5 is a schematic front view of the array configuration of wood blocks inside a wood treatment chamber in accordance with another particular embodiment of the present invention wherein the wood blocks are cylindrical;

FIG. 6 is a schematic front view of the array configuration of wood blocks inside a wood treatment chamber in accordance with another particular embodiment of the present invention wherein the wood block of adjacent rows are tilted with different orientations;

FIG. 7 is a schematic perspective view of the wood blocks of FIG. 6 showing the wood support used to support the wood blocks in the treatment chamber; and

FIG. 8 is a flow chart illustrating a method of treating wood in a treatment chamber.

It will be noted that throughout the appended drawings, like features are identified by like reference numerals.

### DETAILED DESCRIPTION

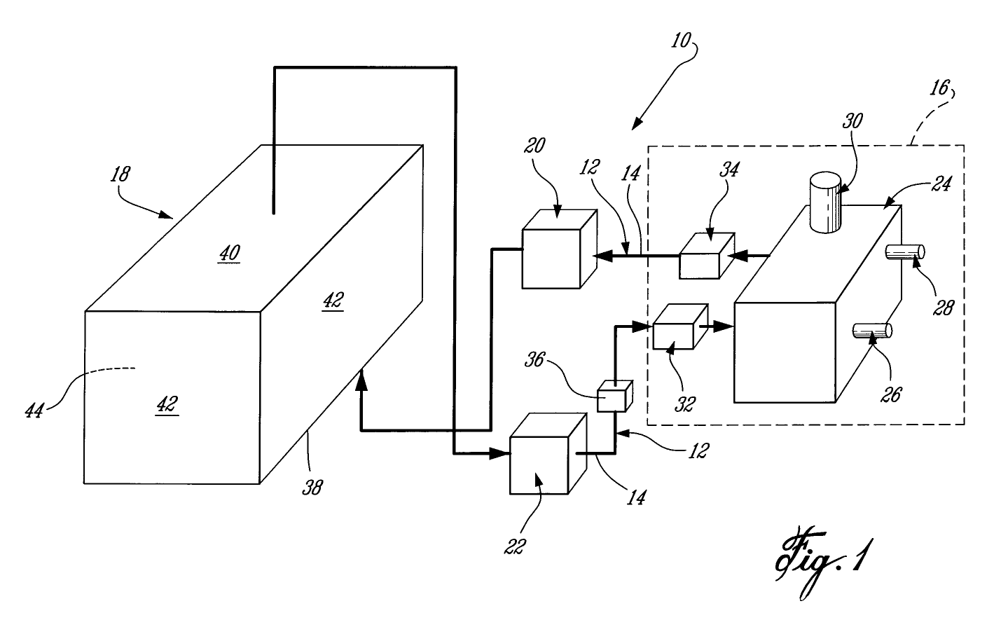

Now referring to the drawings, FIG. 1 shows a closed loop system 10 for treating wood, including drying or thermally treating wood. Generally, the closed loop system 10 defines a gas path 12 for circulating a flow of gas 14 from a gas treatment unit 16 to a wood treatment chamber 18 and back to the gas treatment unit 16 again. The closed loop system 10 includes a first and second fan 20 and 22, or blowers, along the gas path 12 between the gas treatment unit 16 and the wood treatment chamber 18 for maintaining a continuous flow of gas 14 therebetween. The fans 20 and 22 are used to drive the flow of gas such that the first fan 20 blows the gas in the wood treatment chamber 18 and the second fan 22 sucks the gas from the chamber 18 and thrusts it back into the gas treatment unit 16. Notably, the second fan 22 sucks the gas while keeping a positive pressure in the wood treatment chamber 18 so as to prevent cold gas infiltration therein.

The gas treatment unit 16 controls both the temperature and the humidity of the gas flowing through the closed loop system 10 including several chambers in which the gas is conditioned in accordance with the requirements of a particular wood treatment process. More specifically, the gas treatment unit 16 comprises a combustion chamber 24 including first and second burners 26 and 28 for controlling the gas temperature. The first burner 26 heats the gas before it continues along the gas path 12 past the first fan 20 and into the wood treatment chamber 18. The second burner 28 destroys noxious components present in the gas sucked by the second fan 22 from the wood treatment chamber 18 before releasing a portion of the gas out of the closed loop system 10. The gas treatment unit 16 includes a chimney 30 for emitting the gas into the surrounding atmosphere.

Furthermore, the gas treatment unit 16 also includes a dehumidification chamber 32 and a humidification chamber 34. As shown in FIG. 1, the humidification chamber 34 is located between the gas treatment unit 16 and the wood treatment chamber 18 in the closed loop system 10 such that the gas flow 14 exiting the gas treatment unit 16 passes through the humidification chamber 34 before being admitted to the wood treatment chamber 18. The contrary is the case for the dehumidification chamber 32 whereby the gas flow 14 exiting the wood treatment chamber 18 passes therethrough before entering the gas treatment chamber 16. Notably, the physical location of the dehumidification and humidification chambers 32 and 34 could be changed.

The dehumidification chamber 32 has cooling elements to condense the gas humidity and the humidification chamber 34 has humidity injectors to increase the gas humidity. Therefore, the gas humidity can be adjusted in accordance with the wood treatment being carried out allowing for the closed loop system 10 to be used either for wood drying or high temperature heat treatment.

Moreover, the humidification chamber 34 adds water either in liquid or vapor form to the gas flow depending on if the wood is being dried or high temperature heat treated. For wood drying, where the gas flow 14 reaches temperatures up to approximately 120° C., vapor is generated by water circulation and added to the flow of gas 14 to prevent gas cooling. In one embodiment, the water is circulated through a coil disposed in the chimney inlet (not shown). The portion of hot gas released through the chimney 30 acts to heat the coil which in turn acts to heat the circulating water to produce vapor. Therefore, the closed loop system 10 is advantageously designed to reduce the overall energy consumption by locating the coil in the chimney inlet.

For high temperature heat treatment, the wood releases volatiles when exposed to temperatures above a threshold. Due to the combustion of the volatiles, the gas flow 14 can reach high temperatures. Therefore, the humidification chamber 34 uses liquid water injection during high temperature heat treatment to cool down the gas flow 14 below a predetermined temperature.

The wood treatment chamber 18 has a floor 38, a ceiling 40 and side walls 42 defining a large enclosure 44 adapted to receive wood blocks therein. The wood treatment chamber 18 removes moisture from wood by the circulation of heated gas such as air. Thus, the wood treatment chamber 18 relies on the fans 20 and 22 to maintain a gas flow 14 by exhausting the gas and replacing it with new gas. The introduction and removal of gas is carried out uniformly so as to promote uniform treatment of each wood block.

The gas flow 14 is introduced at the bottom of the wood treatment chamber 18 through the floor 38 and exits through the ceiling 40 of the chamber 18, thereby providing an upward gas flow in the chamber 18. The ascending circulation of gas is consistent with the natural tendency of hot and humid gas to rise. Therefore, the wood treatment chamber 18 is not dimensionally limited to any given size as would be the case for a chamber with horizontal gas flow due to the nature of hot gas. The ascending circulation of gas allows for the dimensions of the wood treatment chamber 18 to be adjusted depending on the amount of wood or production rate desired. Nevertheless, a person skilled in the art will appreciate that the ascending gas flow is one embodiment and that the method of the present invention is not limited thereto.

In both the wood drying process and the thermal wood treatment process a certain quantity of humidity must be removed. Notably, the thermal wood treatment process can be carried out following the wood drying process, or can be carried out on pre-dried wood pieces. Pre-dried wood also contains some humidity that is removed naturally by the increase in temperature during treatment. The time required to carry out the thermal wood treatment process on pre-dried wood is faster than if the thermal wood treatment process follows drying.

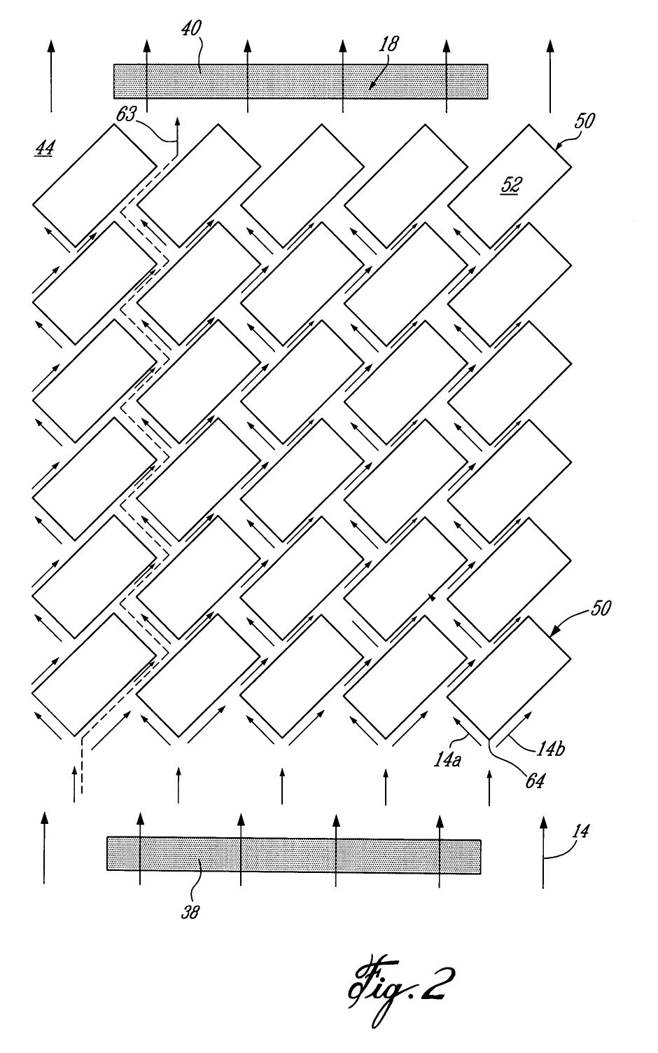

Now referring to FIGS. 2, 3 and 4, the enclosure 44 of the wood treatment chamber 18 is shown filled with wood blocks 50 in accordance with a particular embodiment of the present invention. The wood blocks 50 each have a front face 52, a rear face 54 and four side faces 56, 58, 60 and 62 respectively defining a generally rectangular shape. The side faces 56, 58, 60 and 62 intersect along edges 64, 66, 68 and 70 extending along the length of the wood block 50.

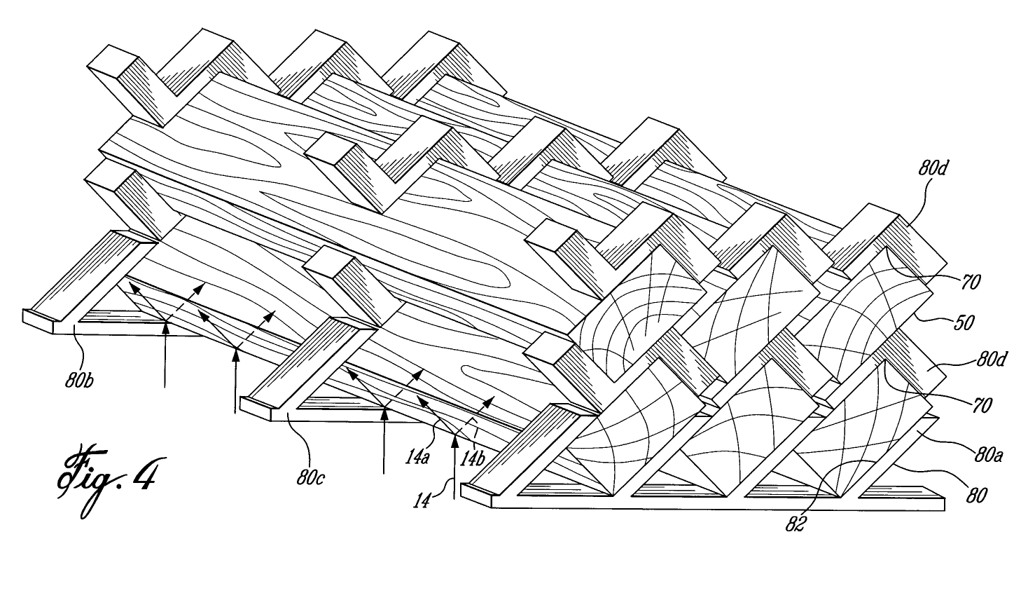

The wood blocks 50 are spaced-apart from one another in an orderly offset array configuration supported by wood supports 80 (see FIG. 4). The spacing between the wood blocks 50 is preferably in a range from 0.5 cm to 1.0 cm. More specifically, the wood blocks 50 are positioned in a pattern thereby defining a non-linear path 63 for the gas flow 14 to circulate between the wood blocks 50. The pattern is further defined by a plurality of rows of wood blocks disposed transversally to the gas flow, i.e., one row is placed on top of the other in the general gas flow direction 14. The rows are in spaced relation and the wood blocks of the second, fourth and sixth rows are offset relative to the wood blocks 50 of the adjacent preceding row respectively (i.e., the first, third and fifth rows) relative to the general gas flow direction 14. For example, a wood block 50 in the second row is positioned between a pair of adjacent wood blocks 50 of the first row. The above-described offset configuration or pattern of spaced-apart wood blocks 50 is conducive to optimizing the circulation of gas flow 14 around the wood blocks 50 to maximize the drying or thermal treatment process.

The wood blocks 50 are angled with respect to the flow of gas 14. More specifically, an optimal angular orientation is also determined to generate optimal gas circulation around the wood blocks 50. In this particular embodiment, the wood blocks 50 are positioned with one of the edges, namely edge 64, pointing directly toward the oncoming gas flow 14. Thus, the edge 64 is defined as a leading edge 64.

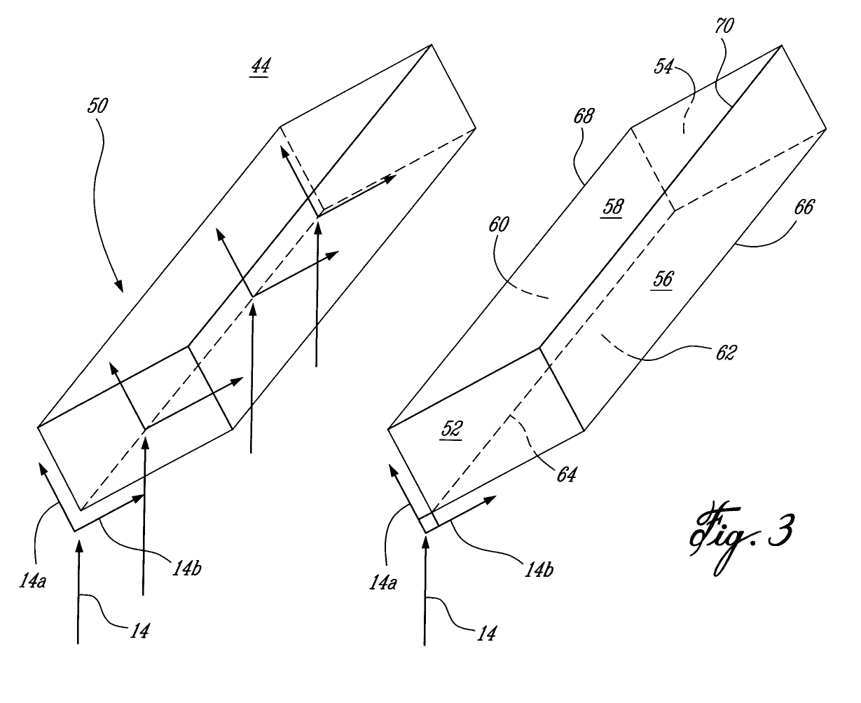

Referring to FIG. 3, it can be seen that the leading edge pointing into the oncoming flow of gas 14 causes the ascending flow of gas 14 to divide into sub-flows identified by 14a and 14b. As the leading edge is directly aligned with the flow of gas 14, the latter divides into sub-flows 14a, 14b directed at 45 degree angles from the vertical direction defined by the ascending gas flow 14 thereby contouring the side faces 56, 58, 60 and 62 of the wood block 50. Therefore, the slanted spaced-apart offset position of the wood blocks 50 in the wood treatment chamber 18 allows for the flow of gas 14 to easily circulate around the wood blocks 50. Consequently, all the faces 52, 54, 56, 58, 60 and 62 of each wood block 50 remain in contact with the gas flow 14 during treatment. Hence, the time required to dry or treat the wood is minimized. The angled spaced-apart offset wood block position helps in treating all the wood in the chamber 18 uniformly and quickly at all times.

Generally, the difficulty in drying or treating wood increases in relation to the size of the block of wood. Advantageously, in the present system 10 the dimensions of the wood blocks 50 are less problematic because of the intimate contact between the wood blocks 50 and the flow of gas 14

FIG. 4 shows the wood support 80 used to space apart and to support the wood pieces 50 according to the embodiment of FIG. 2. The wood support 80 comprises a standing support 80a and 80b is disposed at each end of the first row of wood pieces and a third standing support 80c is disposed midway. The wood support 80 comprises L-shaped separators 80d bearing on the top edge 70 of the wood pieces 50 of the first row such that the inside surfaces of the “L” matches the shape of the top edge 70. Each wood piece 50 of the second row is held on outside surfaces of two adjacent L-shaped separators 80d. Similarly to the supports 80a, 80b, 80c of the first row, a separator 80d of the second row is disposed at each ends and midlength of the wood pieces 50. The wood support 80 comprises tilted surfaces 82 for receiving said wood blocks at an angle relative to the gas flow as described hereinabove. Wood blocks of the first row are typically disposed one-by-one on the supports 80a, 80b and 80c. The separators 80d are then installed over the first row, the wood blocks of the second row are disposed over the first row one-by-one, and so on for the next rows. In another embodiment, a plurality of L-shaped separators 80d connects such that it defines a zig-zag-shaped separator. It is noted that more or less than three separators 80a, 80b, 80c may be used along the length of the wood pieces. Also, the separate L-shaped separators could be provided as an integral zig-zag shaped piece.

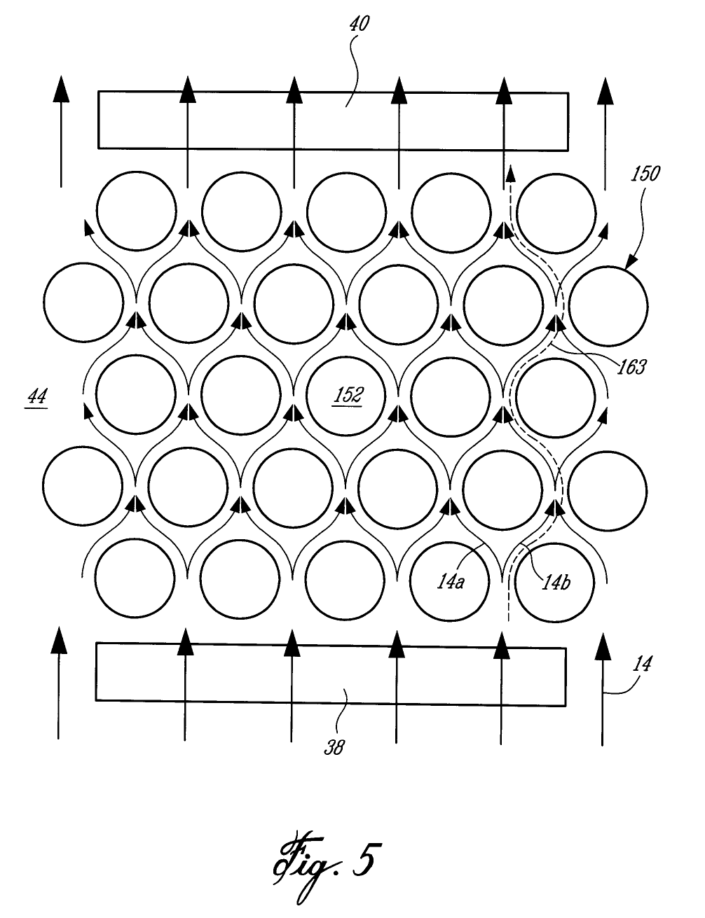

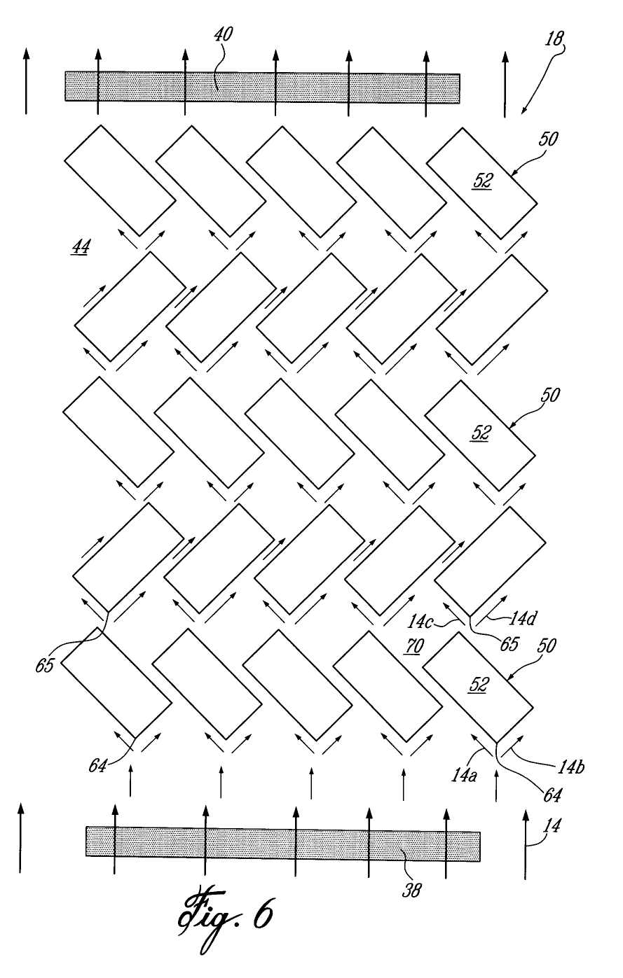

Now referring to FIG. 5, the enclosure 44 of the wood treatment chamber 18 is shown filled with wood pieces 150 in accordance with a particular embodiment of the present invention. The wood pieces 150 are cylindrical in shape having a substantially circular front face 152. The wood pieces 150 are spaced-apart from one another supported by separators in a similar configuration to the embodiment shown in FIG. 6. The pattern is determined so as to optimize gas flow 14 circulation around the wood pieces 150. By offsetting the wood pieces of adjacent rows, a non-linear flow path 163 is created. Thus, the gas flow 14 traveling in a given direction is forced to sub-divide into sub flows 14a and 14b in offset directions when the gas flow 14 comes into contact with a wood piece 150. The sub-flows 14a and 14b flow on opposite sides of a wood piece 150 before being forced to change direction again by the next wood piece 150 in defining the non-linear pathway 163. Thus, the gas flow 14 travels in a general gas flow direction, which in this case is from the floor 38 of the wood treatment chamber 18 to the ceiling 40, through a non-linear gas path 163.

Now referring to FIG. 6, the enclosure 44 of the wood treatment chamber 18 is shown filled with wood blocks 50 in accordance with another particular embodiment of the present invention. The wood blocks 50 are rectangular and are disposed similarly to the embodiment of FIG. 2 but wood pieces of adjacent rows are tilted with alternate angles, i.e. the blocks of the first, third and fifth rows are tilted with a 45-degree orientation to point their leading edge 64 toward the gas flow, while blocks of the second, forth and sixth rows are tilted with a minus 45-degree orientation from the vertical direction defined by the ascending gas flow 14. This configuration provides that none of the wood blocks is aligned with a wood block of the next adjacent row. Linear paths of gas flows are thereby further broken.

The leading edge 64 pointing toward the oncoming flow of gas 14 causes the ascending flow of gas 14 to divide into sub-flows identified by 14a and 14b which circulates on respective sides of the wood block of the first row. As the gas flows 14a and 14b reach the leading edge 65 of the second row of wood blocks 50, they are again split into sub-flows 14c and 14d.

In the arrangement illustrated in FIG. 6, the wood blocks of adjacent rows are not meshed together as in the arrangement of FIG. 2, but meshing of alternately oriented rectangular wood blocks is also possible and breaks all possible linear paths of gas flow, such as the diagonal linear paths of the arrangement of FIG. 2. However, the open space 70 provided between the non-meshed adjacent rows provide a turbulence area which disperses the gas flow before it hits the second row of wood blocks 50. The turbulence area may help in uniformly distributing the air flow 14 in-between the wood blocks 50. The offset of adjacent rows may be varied to maximize the global length of the path of the gas flow through the wood blocks 50 in the enclosure 44 so as to optimize the moisture or heat exchange between the wood blocks 50 and the gas.

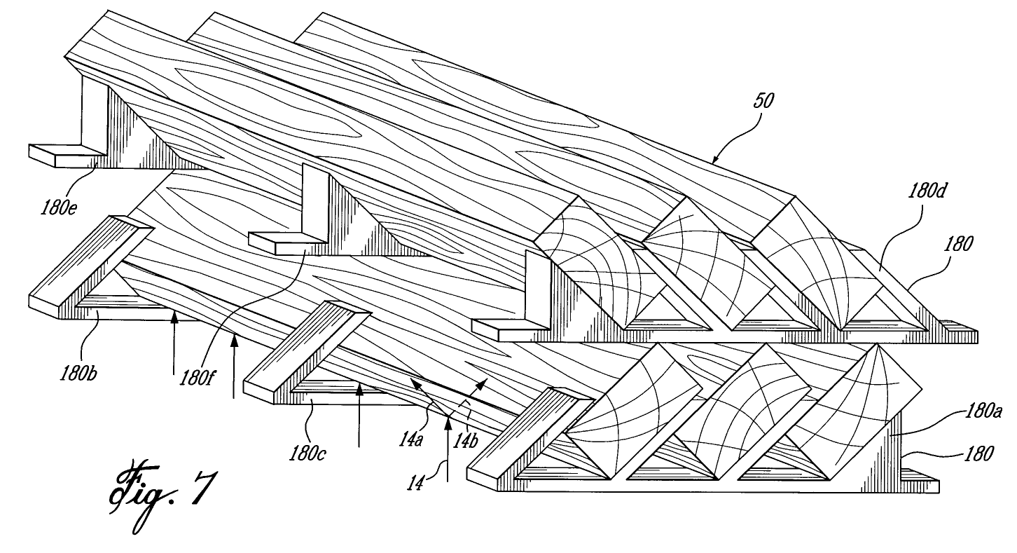

FIG. 7 shows the wood support 180 used to space apart and to support the wood pieces 50 according to the embodiment of FIG. 6. The wood support 180 comprises a standing support 180a and 180b disposed at each end of the first row of wood pieces and a third standing support 180c disposed midway. The wood supports 180d, 180e and 180f of the second row of wood pieces are supports standing on the first row and are disposed similarly to the standing supports 180a, 180b and 180c or the first row.

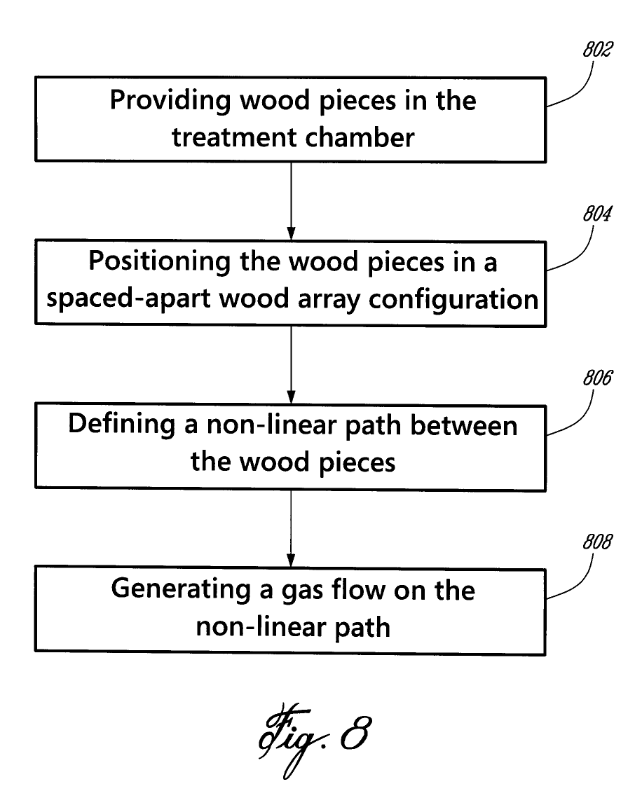

FIG. 8 illustrates a method of treating wood in a treatment chamber according to the wood configuration described herein above. In step 802, a plurality of wood pieces is provided in the treatment chamber. In step 804, the wood pieces are positioned in a spaced-apart wood array configuration in the treatment chamber. The separators such as described in reference with FIGS. 4 and 7 are typically used to spaced-apart the wood pieces. In step 806, a non-linear path is defined between said wood pieces in the spaced-apart wood array configuration, for circulating a gas flow. The non-linear path is defined using a wood configuration such as the ones described with reference to FIGS. 2, 5 and 6. In the embodiment of FIG. 2, the wood pieces are tilted at an angle relative to the gas flow such that the leading edges 64 and 65 of the wood pieces is pointed toward the oncoming gas flow. Suitable non-linear paths are non-linear path 63 of FIG. 2 and non-linear path 163 of FIG. 5. In step 808, a gas flow is generated on the non-linear path in-between the wood pieces in a general gas flow direction.

The above description is meant to be exemplary only, and one skilled in the art will recognize that changes may be made to the embodiments described without department from the scope of the invention disclosed. For example, a person skilled in the art will appreciate that the wood may be provided in various shapes, and therefore, the method of the present invention is not limited to wood blocks having a rectangular or cylindrical shape. In another example, a person skilled in the art will recognize that the wood pieces may be angled in any suitable manner to promote the circulation of gas flow around the wood pieces. Still further, the wood placement pattern may also vary from the embodiments shown. For example, the spacing between adjacent rows of wood pieces may be larger so that wood pieces of adjacent rows do not mesh as it is the case in the embodiment of FIG. 2. Furthermore, the gas is not required to flow vertically. Side injection of the gas is also possible. The system for treating wood may also work in an open loop instead of a closed loop. Still other modifications which fall within the scope of the present invention will be apparent to those skilled in the art, in light of a review of this disclosure, and such modifications are intended to fall within the appended claims.

1. A method of treating wood in a treatment chamber, comprising the steps of:
providing a plurality of wood pieces in the treatment chamber;
positioning a first horizontally extending row of said wood pieces in the treatment chamber, the first row wood pieces being spaced-apart from one another;
positioning a second horizontally extending row of said wood pieces in the treatment chamber above the first horizontally extending row, the second row wood pieces being spaced-apart from one another and being offset and spaced-apart from the first row wood pieces; and
introducing an ascending gas flow substantially uniformly in the treatment chamber through a bottom floor of the treatment chamber extending below the first horizontally extending row of said wood pieces, the gas flow flowing upwardly in the treatment chamber in between the wood pieces along a non linear path.

2. The method as claimed in claim 1, wherein said wood pieces have a polygonal cross-section and said positioning comprises tilting said wood pieces at an angle relative to said ascending gas flow, front and rear face lower edges of the wood pieces defining a non null angle with a horizontally extending axis.

3. The method as claimed in claim 1, wherein each of said wood pieces has at least one longitudinally extending edge and wherein said defining comprises pointing said longitudinally extending edge toward the bottom floor.

4. The method as claimed in claim 1, further comprising removing the ascending gas flow substantially uniformly from the treatment chamber through a ceiling wall opposed to the bottom floor and extending above the wood pieces.

5. The method as claimed in claim 1, wherein said bottom floor comprises a plurality of substantially uniformly distributed gas apertures for providing said substantially uniform ascending gas flow in the treatment chamber.

6. The method as claimed in claim 4, wherein said ceiling wall comprises a plurality of substantially uniformly distributed gas apertures for providing said substantially uniform ascending gas flow removal in the treatment chamber.

7. The method as claimed in claim 1, wherein said wood pieces have a polygonal cross-section with front and rear face lower edges and said defining comprises tilting wood blocks of said first row so as to define a first non-null angle between the lower edges of the wood pieces and a horizontally extending axis and tilting wood blocks of said second rows so as to define a second non-null angle between the lower edges of the wood pieces and the horizontally extending axis, said first and said second angle being acute and of opposite signs.

8. The method as claimed in claim 1, wherein said wood pieces have a top and a bottom and positioning comprises positioning the top of the first row wood pieces above the bottom of the second row wood pieces.

9. The method as claimed in claim 8, wherein said first row has a center line and the bottom of the second row wood pieces is above the center line of the first row.

10. The method as claimed in claim 1, wherein said positioning defines a spacing between adjacent wood blocks of a same row, and wherein a value of said spacing is between 0.5 cm and 1.0 cm.

11. A method of treating wood in a treatment chamber, comprising the steps of:
providing a plurality of wood pieces in the treatment chamber;
positioning a first horizontally extending row of wood pieces in the treatment chamber and defining a spacing between adjacent wood pieces;
positioning a second horizontally extending row of wood pieces with the wood pieces of the second horizontally extending row in spaced-relation with the wood pieces of the first horizontally extending row in the treatment chamber, defining a spacing between adjacent wood pieces of the second horizontally extending row, and the second horizontally extending row extending above the first horizontally extending row;
offsetting the wood pieces of said second horizontally extending row from the wood pieces of said first horizontally extending row, wood pieces of said second horizontally extending row being substantially aligned with said spacing between wood pieces of said first horizontally extending row such that such that said wood pieces define a non-linear ascending path between said wood pieces; and
circulating an ascending gas flow substantially uniformly in the treatment chamber between said wood pieces through a bottom floor of the treatment chamber extending below the first horizontally extending row of said wood pieces.

12. The method as claimed in claim 11, wherein a width of said spacing is between 0.5 cm and 1.0 cm.

13. The method as claimed in claim 11, wherein said wood pieces have a polygonal cross-section and said positionings comprise tilting said wood pieces at an angle relative to said ascending gas flow, front and rear face lower edges of the wood pieces defining a non null angle with a horizontally extending axis.

14. The method as claimed in claim 11, wherein each of said wood pieces has at least one longitudinally extending edge and wherein said defining comprises pointing said longitudinally extending edge toward the bottom floor.

15. The method as claimed in claim 11, further comprising removing the ascending gas flow substantially uniformly from the treatment chamber through a ceiling wall opposed to the bottom floor and extending above the wood pieces.

16. The method as claimed in claim 11, wherein said bottom floor comprises a plurality of substantially uniformly distributed gas apertures for providing said substantially uniform ascending gas flow in the treatment chamber.

17. The method as claimed in claim 15, wherein said ceiling wall comprises a plurality of substantially uniformly distributed gas apertures for providing said substantially uniform ascending gas flow removal in the treatment chamber.

18. The method as claimed in claim 11, wherein said wood pieces have a polygonal cross-section with front and rear face lower edges and said defining comprises tilting wood blocks of said first row so as to define a first non-null angle between the lower edges of the wood pieces and a horizontally extending axis and tilting wood blocks of said second rows so as to define a second non-null angle between the lower edges of the wood pieces and the horizontally extending axis, said first and said second angle being acute and of opposite signs.

19. The method as claimed in claim 11, wherein said wood pieces have a top and a bottom and positionings comprise positioning the top of the first row wood pieces above the bottom of the second row wood pieces.

20. The method as claimed in claim 19, wherein said first row has a center line and the bottom of the second row wood pieces is above the center line of the first row.

21. A wood treatment chamber comprising:
a bottom floor having a plurality of substantially uniformly distributed gas inlets defined therein, the gas inlets being connectable to a gas supply;
at least one gas outlet located above the gas inlets for providing an ascending gas flow substantially uniform in the wood treatment chamber; and
a wood piece support defining a first horizontally extending row of wood piece receivers and a second horizontally extending row of wood piece receivers for receiving a plurality of wood pieces in a wood array configuration in the treatment chamber with adjacent wood pieces received in the wood piece receivers being spaced apart and the wood piece receivers of the first horizontally extending row being offset with the wood piece receivers of the second horizontally extending row, the second horizontally extending row of wood piece receivers being located above the first horizontally extending row of wood piece receivers for spacing wood pieces received in the wood piece receivers of the first horizontally extending row from the wood pieces received in the wood piece receivers of the second horizontally extending row.

22. The wood treatment chamber as claimed in claim 21, where said wood piece receivers comprise a tilted surface for receiving said wood pieces at an angle relative to said ascending gas flow.

23. The wood treatment chamber as claimed in claim 22 where each of said wood pieces has at least one longitudinally extending edge and wherein said wood piece receivers receive said wood pieces such that said longitudinally extending edge is pointed toward the bottom floor.

24. The wood treatment chamber as claimed in claim 21, comprising a ceiling wall opposed to the bottom floor and extending above the wood piece support, the at least one gas outlet being located in the ceiling wall.

25. The wood treatment chamber as claimed in claim 24, wherein the ceiling wall comprises substantially uniformly distributed gas outlets for substantially uniformly collecting the ascending gas flow from the treatment chamber.

26. A wood treatment system comprising
a wood treatment chamber having:
a wood piece support defining a first horizontally extending row of wood piece receivers and a second horizontally extending row of wood piece receivers for receiving a plurality of wood pieces in a wood array configuration in the treatment chamber with adjacent wood pieces received in the wood piece receivers being spaced apart and the wood piece receivers of the first horizontally extending row being offset with the wood piece receivers of the second horizontally extending row, the second horizontally extending row of wood piece receivers being located above the first horizontally extending row of wood piece receivers for spacing wood pieces received in the wood piece receivers of the first horizontally extending row from the wood pieces received in the wood piece receivers of the second horizontally extending row;
a bottom floor having a plurality of substantially uniformly distributed gas inlets defined therein, the gas inlets being connectable to a gas supply;
at least one gas outlet located above the gas inlets for providing an ascending gas flow substantially uniform in the wood treatment chamber;
a gas treatment unit for controlling a temperature and a humidity of said gas flow; and
a fan for circulating said gas flow from said wood treatment chamber, to said gas treatment unit and again to said wood treatment chamber.

27. The wood treatment system as claimed in claim 26, where said wood piece receivers comprise a tilted surface for receiving said wood pieces at an angle relative to said ascending gas flow.

28. The wood treatment system as claimed in claim 26, where said wood piece receivers comprise a tilted surface for receiving said wood pieces at an angle relative to said ascending gas flow.

29. The wood treatment system as claimed in claim 26, where each of said wood pieces has at least one longitudinally extending edge and wherein said wood piece receivers receive said wood pieces such that said longitudinally extending edge is pointed toward the bottom floor.

30. The wood treatment system as claimed in claim 26, comprising a ceiling wall opposed to the bottom floor and extending above the wood piece support, the at least one gas outlet being located in the ceiling wall.

31. The wood treatment system as claimed in claim 30, wherein the ceiling wall comprises substantially uniformly distributed gas outlets for substantially uniformly collecting the ascending gas flow from the treatment chamber.
